(19) United States
(12) Patent Application Publication
(10) Pub. No.: US 2009/0054231 A1
(43) Pub. Date: Feb. 26, 2009

(54) METHOD FOR PREPARING NANOSTRUCTURED VANADIA-TITANIA CATALYSTS USEFUL FOR DEGRADING CHLORINATED ORGANIC COMPOUNDS BY A FLAME SPRAY PROCESS

(76) Inventors: Jong Soo Jurng, Seoul (KR); Gwi Nam Bae, Seoul (KR); Kang Ho Ahn, Seoul (KR); Jung Eun Lee, Seoul (KR); Jin Young Kim, Seoul (KR); Hyeok Chung, Anyang-si (KR)

Correspondence Address: JONES DAY, 222 EAST 41ST ST, NEW YORK, NY, 10017, US

(21) Appl. No.: 11/967,417

(22) Filed: Dec. 31, 2007

(30) Foreign Application Priority Data
Aug. 24, 2007 (KR) 10-2007-0085321

(51) Int. Cl. B01J 23/22; B05D 3/00

(52) U.S. Cl. 502/350; 427/226

(57) ABSTRACT

The present invention discloses methods for preparing vanadia-titania catalysts in the form of nanostructured particles, where vanadia particles are dispersed at the surface of a titanium dioxide carrier and attached thereto, which are useful for degrading chlorinated organic compounds. The method of the present invention has a number of advantages in that: (i) it is capable of producing vanadia-titania catalysts by a relatively simple process as compared to the conventional wet-type method; (ii) the size of the catalyst particles can be easily regulated; and (iii) the vanadia-titania catalysts prepared according to the method of the present invention exhibit excellent degradation efficiency with respect to chlorinated organic compounds even at a low temperature, compared to catalysts prepared by the wet-type method, due to their nanostructure that provides the catalysts with large reactive surface area and high physical stability.

The present application claims priority from Korean Patent Application 10-2007-85321 filed Aug. 24, 2007, the subject matter of which is incorporated herein by reference.

### FIELD OF THE INVENTION

The present invention relates to a method for preparing vanadia-titania catalysts useful for degrading chlorinated organic compounds by a flame spray process. In particular, the present invention relates to a method for preparing vanadia-titania catalysts in the form of nanostructured particles, where vanadia particles are dispersed at the surface of a titanium dioxide carrier and attached thereto.

### BACKGROUND OF THE INVENTION

Vanadia-titania catalysts have been widely used as catalysts for degrading highly toxic chlorinated organic compounds discharged during the incineration of organic materials and various kinds of combustion procedures. Dioxins are the most toxic man-made organic chemicals that are formed during various combustion processes, such as waste incineration, forest fires, and backyard trash burning, and industrial processes, such as paper pulp bleaching and herbicide manufacturing. During such combustion processes, various kinds of chlorinated organic compounds and dioxins are generated and released and, among them, aromatic compounds having a chloride atom as a substituent can be converted into the dioxin family compounds via a regeneration reaction. Further, the dioxin family compounds can be generated via de novo synthesis by burning organic compounds consisting of carbon and chlorine ingredients. Vanadia-titania catalysts purify exhaust gases generated in combustion apparatuses and release them from there by oxidizing chlorinated organic compounds at vanadia active sites via an oxidation-reduction reaction and modifying or degrading their original structure.

Previously, vanadia-titania catalysts have been prepared by a wet type method, such as an impregnation process or a coprecipitation process, e.g., by impregnating pre-mold titania pellets or powders in a vanadium salt solution and dry calcining them. However, the wet type methods described in the prior art have several problems in that anatase-phase titania is partially converted into rutile-phase titania at a high temperature due to its low specific surface area and low thermostability, leading to a lowering of the catalyst performance. Accordingly, it takes a very long time—several days or more—to prepare the catalyst by the wet type method, since the catalysts need to undergo several steps including dissolution, distillation, drying, pulverizing, and calcining.

In addition, a method has been developed for preparing vanadia-titania aerogel catalysts, which involves performing a supercritical drying of a vanadia-titania wet gel, prepared by a sol-gel method using carbon dioxide, and then firing the dried vanadia-titania gel. This method, however, also suffers from technical problems in that it takes a long time for the vanadia-titania wet gel to mature in the course of preparing the catalysts using the vanadia and titania precursors and that it needs as the last step a drying step using a supercritical fluid, which is economically unfavorable for commercialization.

The present invention is directed to a relatively simple process for preparing vanadia-titania catalysts that can be effectively used for degrading chlorinated organic compounds. The present invention provides a method for preparing nanostructured vanadia-titania catalysts comprising the steps of spraying the precursor solution of vanadia and titania, passing the sprayed precursor solution through a flame at a high temperature and during the passage, producing vanadia-titania catalysts in the form of nanostructured particles via an oxidation reaction, where vanadia particles are dispersed at the surface of a titanium dioxide carrier and attached thereto.

### SUMMARY OF THE INVENTION

The primary objective of the present invention is to provide a relatively simple method for preparing nanostructred vanadia-titania catalysts capable of degrading chlorinated organic compounds by a flame spray process, which is capable of mass producing the catalysts.

Thus, the present invention relates to a method for preparing nanostructured vanadia-titania catalysts using flame spray pyrolysis which comprises the following steps.

1) spraying a precursor solution which is prepared by mixing vanadia and titania precursors;
2) passing droplets of the sprayed precursor solution through a flame using a carrier gas, thereby preparing vanadia-titania catalysts in the form of nanostructured particles via an oxidation reaction, where vanadia particles are dispersed at the surface of a titanium dioxide carrier and attached thereto; and
3) cooling the nanostructured vanadia-titania catalysts and collecting them.

The present invention also relates to nanostructured vanadia-titania catalysts prepared by the above method of the present invention, which are useful for degrading chlorinated organic compounds.

In addition, the present invention relates to a method for degrading chlorinated organic compounds by using the above nanostructured vanadia-titania catalysts of the present invention.

### BRIEF DESCRIPTION OF THE DRAWINGS

FIG. 1 is a schematic diagram illustrating an apparatus used for preparing nanostructured vanadia-titania catalysts by flame spray pyrolysis according to the present invention.

FIGS. 2a-d are transmission electron microscope (TEM) photographs, showing the different nanostructured vanadia-titania catalysts prepared according to the present invention by varying the vanadia content. FIG. 2a: 1.0 wt % vanadia-titania catalyst (scale bar 20 nm); FIG. 2b: 3.5 wt % vanadia-titania catalyst (50 nm); FIG. 2c: 5.0 wt % vanadia-titania catalyst (20 nm); FIG. 2d: 7.0 wt % vanadia-titania catalyst (20 nm).

FIG. 3 shows the different degradation efficiencies of the various vanadia-titania catalysts prepared according to the present invention and prepared by impregnation with respect to 1,2-dichlorobenzene.

### DETAILED DESCRIPTION OF THE INVENTION

The present invention relates to a method for preparing nanostructured vanadia-titania catalysts using flame spray pyrolysis, which comprises the steps of:

1) spraying a precursor solution which is prepared by mixing vanadia and titania precursors;
2) passing droplets of the sprayed precursor solution through a flame using a carrier gas, thereby preparing vanadia-titania catalysts in the form of nanostructured particles via an oxidation reaction, where vanadia particles are dispersed at the surface of a titanium dioxide carrier and attached thereto; and
3) cooling the nanostructured vanadia-titania catalysts and collecting them.

In step 1) of the above method of the present invention, the vanadia precursor and titania precursor are mixed in a weight ratio ranging from 3.5:96.5 (vanadia: titania) to 7:93 (vanadia: titania) and then the prepared precursor solution is sprayed through a capillary tube.

Examples of suitable vanadia precursors for use in this step may include vanadium oxytriisopropoxide ((C₃H₇O)₃VO) and the like, while examples of suitable titania precursors may include titanium-tetraisopropoxide (TTIP, Ti(OCH(CH₃)₂)₄) and the like. If the mixed ratio of the vanadia and titania precursors is not more than or exceeds the above-mentioned range, there exists a problem in that the dioxin degradation efficiency of the prepared vanadia-titania catalysts is decreased. Further, it is preferable to spray the precursor solution at a flow rate ranging from 0.49 to 2.4 ml/hour. If the flow rate is below or above that range, it might be problematic in that the spraying conditions of the precursor solution may be changed or the spraying is not carried out smoothly.

In step 2) of the above method of the present invention, the droplets of the precursor solution sprayed in step 1) are passed through a flame at a high temperature, thereby preparing vanadia-titania catalysts in the form of nanostructured particles via an oxidation reaction, where vanadia particles are dispersed and attached to the surface of a titanium dioxide carrier. The nanostructure of the catalyst particles improves the absorption capacity of the catalyst due to the enhanced specific surface area and enhances degradation efficiency by increasing the number of vanadia active sites.

The droplets of the precursor solution sprayed in step 1) are passed through a flame by using a carrier gas. Examples of the carrier gas suitable for the present invention may include inert gases, such as nitrogen, argon and the like, and it is preferable to maintain the flow rate of the carrier gas at a range of from 1 to 5 l/min. Further, the flame is preferably generated by using hydrogen gas as the fuel gas so as to prevent soot formation, where it is preferable to maintain the flow rate of the hydrogen gas at a range of from 1 to 5 l/min. When the droplets of the sprayed precursor solution are passed through the flame, it is preferable to maintain the temperature of the flame at a range of from 600 to 800° C. If the temperature is higher than 800° C., there are problems in that the anatase phase of titania is converted into a rutile phase and the size of the resulting particles is increased, an unfavorable result. If the temperature is lower than 600° C., it is also problemblematic in that an amorphizing process may occur.

In step 3), the nanostructured vanadia-titania catalyst particles formed in step 2) are cooled down to a temperature ranging from 100 to 150° C. The vanadia-titania catalyst particles are then collected, using the thermophoretic force generated by the temperature gradient.

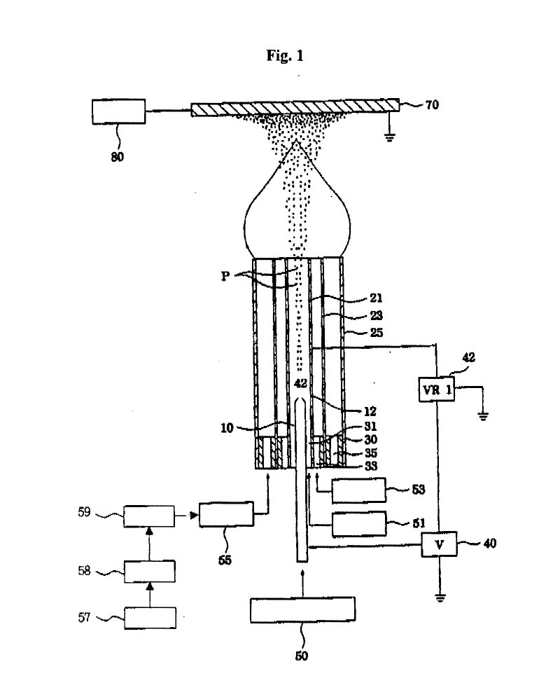

Referring to FIG. 1, the method of the present invention can be described as follows. First, the precursor solution of vanadia and titania is injected through capillary tube 10 into the flame, where the part of capillary tube 10 is located inside first hollow induction duct 21. Capillary tube 10 is equipped with nozzle 12, where spray particles P are emitted at the front end thereof; and is connected to spray solution injection means 50 supplying the precursor solution, which is prepared by mixing vanadia and titania precursors in a suitable weight ratio for generating spray particles P. For spray solution injection means 50, a fixed-amount injection means by using a syringe pump capable of regulating the flow rate of the precursor solution and supplying it to capillary tube 10 or a spray solution injection means by using compressed air or gravity may be used. Capillary tube 10 can be replaced by a container equipped with an orifice.

Power supply 40 applies high voltage to capillary tube 10, while low voltage having the same polarity as applied to capillary tube 10 is applied to first induction duct 21. In order to generate a voltage difference between capillary tube 10 and first induction duct 21, the high voltage of power supply 42 is dropped by using variable resistor 42. When the high voltage and low voltage having the same polarity are applied to capillary tube 10 and first induction duct 21, respectively, as described above, the spray particles generated from nozzle 12 exhibit high electric charge having the same polarity and move toward the surface having a relatively low voltage along the central axis of first induction duct 21 without adhering to the inside wall of first induction duct 21.

Meanwhile, second induction duct 23, coaxial with first induction duct 21, is provided outside of first induction duct 21, while third induction duct 25, coaxial with first induction duct 21, is provided outside of second induction duct 23. Support members 30 are fitted within first, second, third, and fourth induction ducts 21,23,25 and have capillary tube 10 penetrating therethrough. In support members 30, first penetration hole 31 is formed so as to make contact with first induction duct 21, second penetration hole 33 is formed so as to make contact with second induction duct 23, and third penetration hole 35 is formed so as to make contact with third induction duct 25.

In order to quickly transfer spray particles P generated from nozzle 12, a carrier gas for delivering spray particles P is injected into first induction duct 21 through first penetration hole 31 by using typical carrier gas injection means 51, where it is preferable to inject the carrier gas at a flow rate ranging from 1 to 5 l/min by using a flow rate controller for carrier gas injection means 51.

Hydrogen gas, used as the fuel gas for generating the flame, is injected into second induction duct 23 through second penetration hole 33, where it is preferable to inject the hydrogen gas at a flow rate ranging from 1 to 5 l/min by using a flow rate controller for fuel gas injection means 53.

Oxygen gas, used as an oxidizer for incineration, is injected into third induction duct 25 through third penetration hole 35, where it is preferable to inject the oxygen gas at a flow rate ranging from 1 to 5 l/min by using a flow rate controller.

Sheath air used for blocking the flame and the surrounding air for increasing the purity of the catalyst is injected into third induction duct 25 through fourth penetration hole 35, where it is preferable to inject sheath air at a flow rate ranging from 50 to 100 l/min by using a flow rate controller for sheath air injection means 55. In one embodiment of the present invention, after high pressure air is generated by using compressor 57, the air is passed through dryer 58 and high-performance air filter 59 so as to remove the moisture and particulates, thereby obtaining dry and clean air to be used us sheath air.

Collection plate 70, which is electrically grounded, is placed in front of the outlets of first, second, and third induction ducts 21, 23, 25, so as to collet the nanostructured vanadia-titania catalysts generated by a flame spray process, using the thermophoretic force generated by the temperature gradient. Collection plate 70 is also connected to cooling device 80 that cools the collection plate.

The vanadia-titania catalysts prepared according to the method of the present invention by using the apparatus described in FIG. 1 can be mass-produced by a simple process. Moreover, the vanadia-titania catalysts prepared according to the method of the present invention have a nanostructure where vanadia particles are dispersed and attached to the surface of a titanium oxide carrier and, as a result, have large surface areas for reacting with chlorinated organic compounds and show excellent physical stability. Therefore, the vanadia-titania catalysts prepared according to the method of the present invention can degrade chlorinated organic compounds at a low temperature more efficiently than prior art catalysts prepared by the wet-type method.

### EXAMPLES

The following examples are provided to illustrate embodiments of the present invention but are by no means intended to limit its scope.

### Example 1

### Preparation of Vanadia-Titania Catalysts Using the Method of the Present Invention

Vanadium oxytriisopropoxide ((C₃H₇O)₃VO) was added to a titanium-tetraisopropoxide (TTIP, Ti(OCH)(CH₃)₂)₄) solution to obtain various vanadium oxytriisopropoxide concentrations of 1, 3.5, 5, and 7 wt %, respectively. After the precursor solution was sprayed through a capillary tube by using the apparatus shown in FIG. 1, the sprayed particles were passed through a flame having a temperature of 800° C., while vanadia particles are dispersed and attached to the surface of a titanium oxide carrier by an oxidation reaction, thereby generating vanadia-titania catalysts in the form of nanostructured particles. The generated vanadia-titania catalysts were then cooled down to 150° C. and collected from a collector, where the flow rate of the precursor solution was 2.4 ml/hour, that of nitrogen gas, used as a carrier gas, was 1 l/min, that of hydrogen, used as a fuel gas, was 1 l/min, and that of sheath air was 70 l/min.

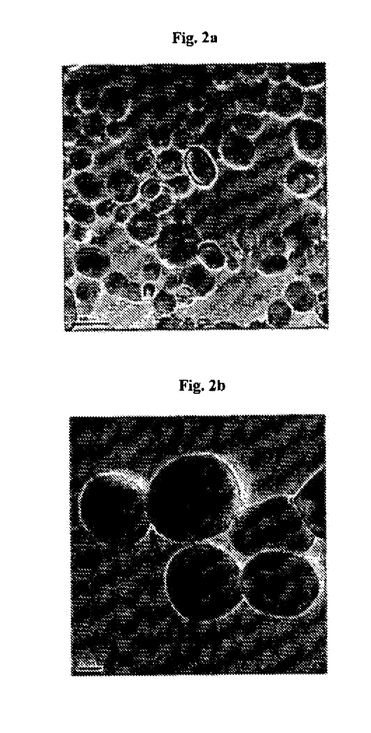

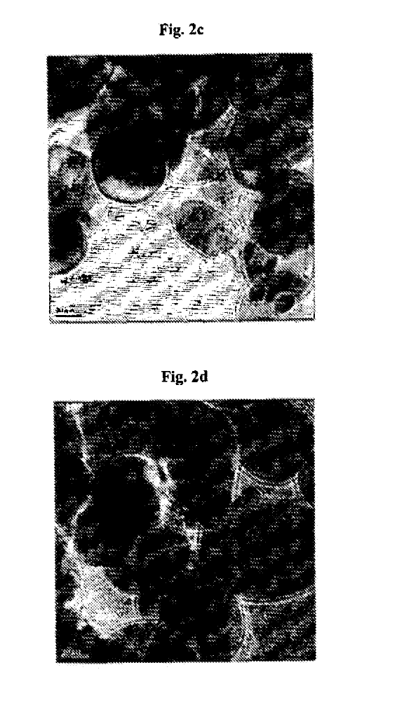

FIGS. 2a-d are transmission electron microscope (TEM) photographs of the vanadia-titania catalysts prepared as described above and having a vanadia content of 1, 3.5, 5, and 7 wt %, respectively, illustrating that the vanadia-titania catalysts have a nanostructure where vanadia particles are dispersed and attached to the surface of a titanium oxide carrier.

### Comparative Example 1

### Preparation of Vanadia-Titania Catalysts Using the Impregnation Method

Vanadia-titania catalysts were prepared by an impregnation process well-known in the art as a method for preparing a catalyst. Vanadium oxytriisopropoxide (3.5 wt %) used as a vanadia precursor was homogeneously dissolved in water together with an acid, impregnated in commercially available titania powder (Degussa, P-25), and then dried by distillation, to prepare the catalysts.

### Test Example 1

In order to find the most optimum conditions where the vanadia-titania catalysts prepared by flame spray pyrolysis in Example 1 are most active a degradation experiment using the catalysts was carried out on 1,2-dichlorobenzene (1,2-DCB), which has been widely used as a substituent for dioxin and is one of the most toxic chlorinated organic compounds contained in exhaust gas from combustion apparatuses. In particular, 0.1 g each of the vanadia-titania catalysts containing the vanadia precursor at a concentration of 1, 3.5, 5, and 7 wt % was introduced into a fixed layer reactor, and their reactivities were examined after a reaction time of 2 hours at various temperatures, i.e., starting at 150° C. and at intervals of 50° C. thereafter up to 400° C. 1,2-Dichlorobenzene was injected into each reactor at a concentration of 2000 ppm and passed through the catalyst layer at a space velocity of 18,000 ml/g_{cat}·h by using 10% oxygen gas supplied as an oxidant of the vanadia-titania catalyst. Before increasing the reaction temperature in each reactor, samples were collected from the upper and lower portions of the catalyst layer and analyzed by gas chromatography with micro-electron capture detection (GC/micro-ECD) to) measure the concentration of 1,2-dichlorobenzene. The degradation efficiency of the vanadia-titania catalyst on 1,2-dichlorobenzene was represented by measuring the amount of 1,2-dichlorobenzene that was removed as the temperature of the catalyst layer increased, based on the initial concentration of 1,2-dichlorobenzene. The same experiments were carried out using the vanadia-titania catalysts prepared by the impregnation process in Comparative Example 1 as a control.

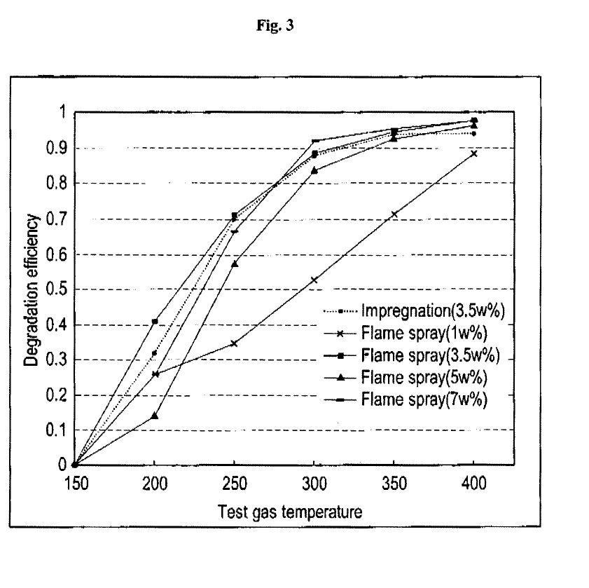

Accordingly, as shown in FIG. 3, the degradation efficiency of the catalyst on 1,2-dichlorobenzene increased as the reaction temperature increased, mid the activity of the catalyst exhibited significant differences depending on the vanadia precursor content. In particular, the degradation efficiency of the vanadia-titania catalysts prepared by the flame spray process according to the present invention was about 10% higher than that of the vanadia-titania catalysts prepared by the impregnation process at a reaction temperature of 200° C., while the degradation efficiencies of the vanadia-titania catalysts prepared by the two different methods were similar at reaction temperatures of 250° C. and higher. At a reaction temperature of 250° C., the vanadia-titania catalysts containing 3.5 wt % of the vanadia precursor showed the highest degradation efficiency on 1,2-dichlorobenzene, compared to the other catalysts, while it, except for the vanadia-titania catalysts containing 7 wt % of the vanadia precursor, also showed excellent degradation efficiency even at a reaction temperature of 300° C. or higher. Therefore, a vanadia-titania catalyst prepared by a flame spray process according to the present invention and having a 3.5 wt % vanadia precursor content, when reacted at a reaction temperature of 350° C. or higher, exhibits a 95% or higher degradation efficiency with respect to 1,2-dichlorobenzene.

Therefore, the method of preparing vanadia-titania catalysts in the form of nanostructured particles where vanadia particles are dispersed and attached to the surface of a titanium oxide carrier by a flame spray process according to the present invention can shorten the manufacturing time, compared to the conventional wet type method, by successively performing the manufacturing steps and is capable of mass-producing the vanadia-titania catalysts. Further, the vanadia-titania catalysts prepared according to the method of the present invention can degrade chlorinated organic compounds contained in exhaust gas from combustion apparatuses at a relatively low temperature of about 200° C. more efficiently than the conventional catalysts and, thus, can be effectively used for degrading chlorinated organic compounds.

Although the invention has been described in detail for the purpose of illustration, it is understood that such detail is solely for that purpose, and variations can be made therein by those skilled in the art without departing from the spirit and scope of the invention which is defined by the following claims.

What is claimed:

1. A method for preparing nanostructured vanadia-titania catalysts using flame spray pyrolysis, which comprises:
spraying a precursor solution which is prepared by mixing vanadia and titania precursors;
passing droplets of the sprayed precursor solution through a flame using a carrier gas, thereby preparing vanadia-titania catalysts in the form of nanostructured particles via an oxidation reaction, wherein vanadia particles are dispersed at the surface of a titanium dioxide carrier and attached thereto; and
cooling the nanostructured vanadia-titania catalyst particles and collecting said catalyst.

2. The method according to claim 1, wherein said precursor solution is prepared by mixing the vanadia precursor and titania precursor in a weight ratio ranging from 3.5:96.5 to 7:93.

3. The method according to claim 1, wherein the vanadia precursor is vanadium oxytriisopropoxide (C₃H₇O)₃VO), and the titania precursor is titaniumtetraisopropoxide (TTIP, Ti(OCH(CH₃)₂)₄).

4. The method according to claim 1, wherein said spraying comprises spraying the precursor solution at a flow rate in the range of from 0.49 to 2.4 ml/hour.

5. The method according to claim 1, wherein the carrier gas is an inert gas selected from the group consisting of nitrogen and argon.

6. The method according to claim 1, wherein said passing comprises passing droplets of the sprayed precursor solution through a flame using a carrier gas at a flow rate in the range of from 1 to 5 l/min.

7. The method according to claim 1, wherein said flame is generated by using hydrogen gas as a fuel and is maintained at a temperature ranging from 600 to 800° C.

8. The method according to claim 7, wherein the hydrogen gas is used at a flow rate in the range of from 1 to 5 l/min.

9. The method according to claim 1, wherein said cooling comprises cooling the vanadia-titania catalyst particles down to a temperature ranging from 100 to 150° C.

10. The method according to claim 1, wherein the vanadia content of the vanadia-titania catalysts after said collecting is in the range from 3 to 4 wt % on the basis of a total catalyst weight.

11. A vanadia-titania catalyst prepared by the method of claim 1, wherein the catalyst has a nanostructure where vanadia particles are dispersed at the surface of a titanium dioxide carrier and attached thereto and the vanadia content is in the range from 3 to 4 wt % on the basis of a total catalyst weight.

12. A method for degrading chlorinated organic compounds comprising using the vanadia-titania catalyst of claim 11.
